(19) United States
(12) Patent Application Publication
(10) Pub. No.: US 2016/0119832 A1
(43) Pub. Date: Apr. 28, 2016

(54) WIRELESS COMMUNICATION BASE STATION SYSTEM, WIRELESS COMMUNICATION SYSTEM, AND WIRELESS MOBILE STATION

(71) Applicant: HITACHI, LTD., Tokyo (JP)

(72) Inventor: Ryotaro NAKAMURA, Tokyo (JP)

(73) Assignee: HITACHI, LTD., Tokyo (JP)

(21) Appl. No.: 14/923,801

(22) Filed: Oct. 27, 2015

(30) Foreign Application Priority Data
Oct. 28, 2014 (JP) 2014-218964

(51) Int. Cl. H04W 36/00; H04W 36/10; H04W 36/36

(52) U.S. Cl. CPC H04W 36/0072; H04W 36/36; H04W 36/10

(57) ABSTRACT

Once an MS's destination area has been determined, the MS receives a frequency list of BSs belonging to the destination area from a broadcasting BS before disconnecting the current network connection, and creates and stores several Search Configurations. When performing a cell search upon arrival at the destination area, the MS connects to a broadcasting BS in the destination and receives a frequency list of the BSs belonging to the destination area. The MS compares the frequency list that it maintains with the frequency list broadcasted from the BS in the destination and performs a cell search according to the result of the comparison. This leads to achieving reliable network connection and reducing time to establish connection.

### CLAIM OF PRIORITY

The present application claims priority from Japanese patent application serial no. 2014-218964, filed on Oct. 28, 2014, the content of which is hereby incorporated by reference into this application.

### TECHNICAL FIELD

The present invention relates to a wireless communication base station system, a wireless communication system, and a wireless mobile station. More particularly, the invention relates to a wireless communication base station system, a wireless communication system, and a wireless mobile station elaborated to reduce time a wireless mobile station takes to complete a cell search.

### BACKGROUND

Generally, when a wireless mobile station (hereinafter referred to as MS) initiates wireless communication, the MS performs network entry via a wireless base station (hereinafter referred to as BS). Network entry is processing that the MS must perform to establish connection to a network of a wireless communication system. In a phase before the MS performs network entry, the MS performs a cell search operation to search through radio waves emitted by its surrounding base stations. The MS searches through a search range of frequencies (from a start frequency to an end frequency) assigned to a wireless communication system in determined frequency gaps (frequency steps). The MS checks to see whether or not there is a BS whose center frequency matches a frequency to search for by the cell search. If the MS has detected a BS having a center frequency that enables communication during the search, the MS attains synchronization with the BS and then initiates network entry processing.

However, an MS typically performs a search in frequency steps that are finer than frequency steps between center frequencies that BSs use. Consequently, a cell search takes much time under the assumption that an MS searches through all applicable frequencies within a search range.

Accordingly, in a technique which is disclosed in Japanese Unexamined Patent Application Publication No. 2007-116561, from a mobile communication network accessed by a mobile terminal, the mobile terminal acquires information representing frequencies that are used in the mobile communication network and stores that information within it. When performing a cell search over a search range of frequencies, the mobile terminal skips frequencies that obviously do not match the center frequencies of BSs in the mobile communication network. Furthermore, based on a search result, the mobile terminal expands a range of frequencies to skip, thus reducing time for a subsequent cell search.

### SUMMARY OF THE INVENTION

When an MS performs a cell search, the MS takes a certain amount of time to complete the cell search, if a search range and frequency steps are not taken into consideration. In a wireless communication system required to have high reliability, once an MS has entered a BS area, time the MS takes to connect to a network is desired to be as short as possible. Thus, it is needed to minimize time that the MS takes to complete a cell search.

In the present invention, Aeronautical Mobile Airport Communication System (AeroMACS) which is built on the basis of Mobile Worldwide Interoperability for Microwave Access (WiMAX) technology is assumed to be used. AeroMACS is one of wireless communication systems to which the present invention is intended to apply. An application scope of AeroMACS is the surface of an airport (the whole airport). AeroMACS provides a high-speed mobile communication system for airports. For AeroMACS, reliable and rapid communication is required to implement operations involved in flight operations on the surface of an airport, which are taking off and landing of aircrafts. Thus, it is required of AeroMACS to reduce time required to initiate communication with a BS and initiate communication reliably.

A cell search in AeroMACS is described. In the AeroMACS specs, a start frequency is 5095 MHz and an end frequency is 5145 MHz. Because frequency steps are 250 kHz, if an MS performs a search through all applicable frequencies within a search range, the MS is to search through frequencies from 5095 MHz to 5145 MHz in 250 kHz steps. However, the width of gaps between the center frequencies of BSs adopted in AeroMACS is 5 MHz (the center frequencies are adopted from among frequencies spaced by a 5-MHz gap including 5095 MHz, 5100 MHz, etc. up to 5145 MHz).

Consequently, at an MS, a cell search is to be performed in very fine frequency steps. Under the conditions mentioned above, if the center frequency of a BS selected as a target access point for an MS is 5095 MHz which is the start frequency in the AeroMACS specs, the MS will complete a cell search by one search action. But if the center frequency of the BS selected as the target access point is set to 5145 MHz which is the end frequency, the MS needs to perform search actions 201 times to complete a cell search.

A significant difference occurring in the number of search actions results in a difference in the cell search time until connection is established. When compared with the processing time required for network entry, it is undesirable that processing of a cell search takes very long for a BS whose center frequency is set to the end frequency, which is the worst-case scenario.

In addition, even if an MS is able to uniquely store the center frequencies of BSs to search and a situation allows the MS to complete a cell search by one search action, airport surface communications may be affected by weather or equipment trouble and, consequently, a destination network manager may change the center frequencies of BSs or the location to which the MS is destined to move. For this reason, it may happen that the MS cannot use information representing the center frequencies of BSs which are uniquely set within it because the center frequencies have been changed just by making an MS uniquely store the center frequencies of BSs, with the result that the MS has to perform a cell search over a search range of frequencies. A time-consuming cell search over a search range of frequencies defined in the specs of a communication system should be performed exclusively for use as a final measure.

To solve a problem discussed above, there is provided a wireless communication base station system including a first broadcasting wireless base station that broadcasts information on wireless base stations installed in a first location, a second broadcasting wireless base station that broadcasts information on wireless base stations installed in a second location, and a frequency management entity. The frequency management entity includes a control unit that performs message transmission and reception and a storage unit that stores information representing center frequencies which are used by wireless base stations in the second location and a coverage area. The control unit, upon receiving a message requesting information on the wireless base stations installed in the second location from a wireless mobile station which is going to move from the first location to the second location, transmits information on the wireless base stations installed in the second location, which is stored in the storage unit, to the wireless mobile station via the first broadcasting wireless base station.

There is also provided a mobile wireless station that may be connected to a wireless communication base station system including a first broadcasting wireless base station that broadcasts information on wireless base stations installed in a first location, a second broadcasting wireless base station that broadcasts information on wireless base stations installed in a second location, and a frequency management entity. The mobile wireless station includes a mobile station control unit that performs message transmission and reception and compares information on wireless base stations and a mobile station storage unit. The mobile station control unit, upon receiving information on base stations from the frequency management entity via the first broadcasting wireless base station and deciding that a plurality of the second wireless base stations serve the coverage area, creates an Area Search Configuration in which the smallest and largest ones of center frequencies used by the plurality of second wireless base stations are set as search start and end frequencies for a cell search and a frequency step size to search defined in the wireless communication system is set as frequency steps, and stores the Area Search Configuration into the mobile station storage unit. The mobile station control unit, upon receiving the information on base stations and deciding that one second wireless base station serves the coverage area, creates an Area Search Configuration in which a center frequency used by the second wireless base station is set as search start and end frequencies, and stores the Area Search Configuration into the mobile station storage unit.

There is further provided a wireless communication system combining the wireless communication base station system with the mobile wireless station.

According to the present invention, it is possible to reduce time that an MS takes to connect to a network. Even when a target access point (BS) has been changed, a cell search for an intended frequency of the target access point can be performed.

### BRIEF DESCRIPTION OF THE DRAWINGS

Preferred embodiments of the present invention will now be described in conjunction with the accompanying drawings, in which;

FIG. 1 is a block diagram to explain a network structure;

FIG. 2 is a block diagram to explain an MS structure;

FIG. 3 is a block diagram to explain a frequency management entity structure;

FIG. 4 is a sequence diagram to explain a process of updating a frequency list;

FIG. 5 is a diagram to explain a home location frequency list;

FIG. 6 is a diagram to explain a foreign location frequency list;

FIG. 7 is a sequence diagram to explain a process in which an MS receives a frequency list;

FIG. 8 is a flowchart to explain a process of creating Search Configs;

FIG. 9 is a diagram to explain a search list;

FIG. 10 is a flowchart to explain a process of using Search Configs;

FIG. 11 is a diagram to an aircraft which is going to arrive at an airport and the coverage areas of BSs;

FIG. 12 is a flowchart to explain a process of performing a cell search using Area Search Config;

FIG. 13 is a flowchart to explain a process of performing a cell search using Location Search Config;

FIG. 14 is a diagram to explain cell search processing using Area Search Config A;

FIG. 15 is a diagram to explain cell search processing using Area Search Config C;

FIG. 16 is a diagram to explain cell search processing using Location Search Config; and

FIG. 17 is a diagram to explain cell search processing using Default Search Config.

### DETAILED DESCRIPTION

In the following, modes will be described in detail using embodiments and with reference to the drawings.

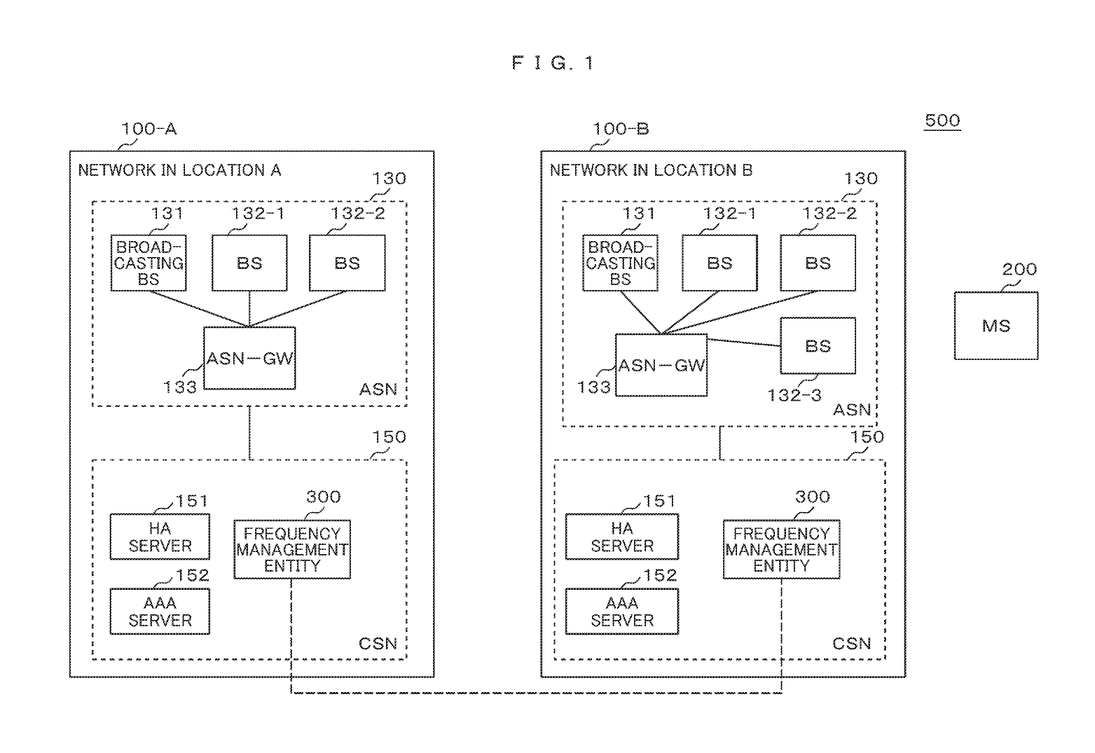

Referring to FIG. 1, descriptions are provided for a structure of a communication system and AeroMACS networks. In FIG. 1, a communication system 500 is configured including networks in locations (AeroMACS networks) 100 and an MS 200. Each AeroMACS network 100 is comprised of an Access Service Network (ASN) 130 and a Connectivity Service Network (CSN) 150.

The ASN 130 has a wireless connection function for communication with an MS 200. The ASN 130 provides a function of connecting a MAC layer for management of radio resources information and a physical layer. The ASN 130 is configured including a broadcasting BS 131, BSs 132, and an ASN-Gateway (GW) 133. The broadcasting BS 131 is a base station that provides a frequency list to the MS 200. The BSs 132 are common base stations. The ASN-GW 133 ensures connectivity of the BSs 131, 132 with a Home Agent (HA) server 151 between the CSN 150 and the ASN 130. The broadcasting BS 131 in a location A is denoted as the broadcasting BS 131-A and the BSs 132 in the location are denoted as the BSs 132-A; the same applies to BSs in a location B.

The CSN 150 performs tunneling to an MS 200. The CSN 150 provides an IP connection function including IP address distribution and communication channel processing using DHCP. The CSN is configured including an Authentication Authorization Accounting (AAA) server 152, an HA server 151, and a frequency management entity 300. The AAA server 152 is a server that performs authentication, authorization, and accounting of an MS. The HA server 151 is a router that provides local communication within the CSN. The frequency management entity 300 transmits the frequencies of BSs in each location to an MS.

In the communication system 500, an MS 200 is a wireless mobile station installed in an aircraft which moves from one location to another. While staying in the location A, the MS 200 connects to the CSN 150 including the frequency management entity 300 via the broadcasting BS 131-A or any of the BSs 132-A and the ASN-GW 133. When the MS moves out of the location A, the MS 200 performs disconnection processing via the BS communicating with it. When the MS arrives in its destination location B, the MS 200 performs a cell search for the center frequency of a broadcasting BS 131-B, which is stored within it at takeoff from the location A, and detects the center frequency of the broadcasting BS 131-B.

The MS 200 attains synchronization with the broadcasting BS 131-B and performs network entry processing. Once the MS has connected to the network, the broadcasting BS 131-B transmits the center frequencies of BSs 132-1 to 132-3 in the location B to the MS 200 by use of the frequency management entity 300. The MS 200 compares the center frequencies of the BSs 132-1 to 132-3 which are stored within it at takeoff from the location A with the center frequencies of the BSs 132-1 to 132-3 received from the broadcasting BS 131-B in the location B and decides whether or not the comparison result is matched.

If the comparison result is matched, the MS 200 performs a cell search using a Search Configuration (hereinafter referred to as a Search Config) stored in a search list which the MS created when it is in the location A. The MS 200 checks to see whether or not there is a BS whose center frequency matches a frequency to search for among the BSs 132-1 to 132-3 in the location B. When the MS 200 has detected a BS whose center frequency matches a frequency to search for during the cell search, the MS 200 attains synchronization with the BS 132 and performs a handover from the broadcasting BS 131.

If the comparison result is unmatched, the MS 200 creates a Search Config, using the center frequencies acquired from the broadcasting BS 131-B, and performs a cell search. The MS 200 checks to see whether or not there is a BS having a center frequency that enables communication among the BSs 132-1 to 132-3 in the location B. When the MS 200 has detected a BS with which it can communicate during the cell search, the MS 200 attains synchronization with the BS 132 and performs handover processing from the broadcasting BS 131.

Although only one MS 200 is depicted in FIG. 1, plural MSs can connect to an appropriate one of the BSs. In the system structure depicted, respective frequency management entities 300 are installed in the locations A and B. However, the structure may be modified as follows: these entities are connected by the Internet which is indicated by a dotted line to provide a frequency management entity 300 that enables mutual management. If just one BS is used in an AeroMACS network due to the scale of a location, just one broadcasting BS may be provided in the network structure.

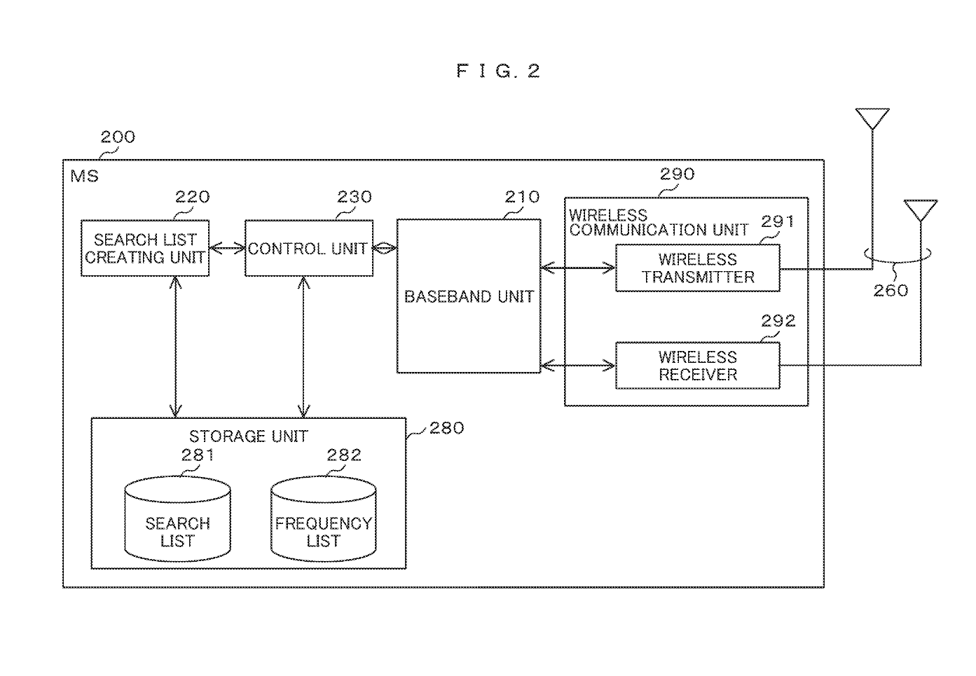

Referring to FIG. 2, an MS structure is described. In FIG. 2, an MS 200 includes a baseband unit 210, a search list creating unit 220, a control unit 230, antenna 260, a storage unit 280, and a wireless communication unit 290.

The baseband unit 210 performs modulation and demodulation processing on radio signals. The search list creating unit 220 creates a search list. The control unit 230 performs control of all components of the MS. The control unit 230 performs comparison between the center frequencies of base stations registered in a search list which the MS creates before its departure and the center frequencies of base stations in a location in which the MS has arrived, received from a broadcasting BS in the location in which the MS has arrived. The antenna 260 transmits and receives radio signals. The storage unit 280 records data. The wireless communication unit 290 executes communication with a BS.

The wireless communication unit 290 includes a wireless transmitter 291 which transmits radio signals and a wireless receiver 292 which receives radio signals. The storage unit 280 holds a search list 281 and a frequency list 282.

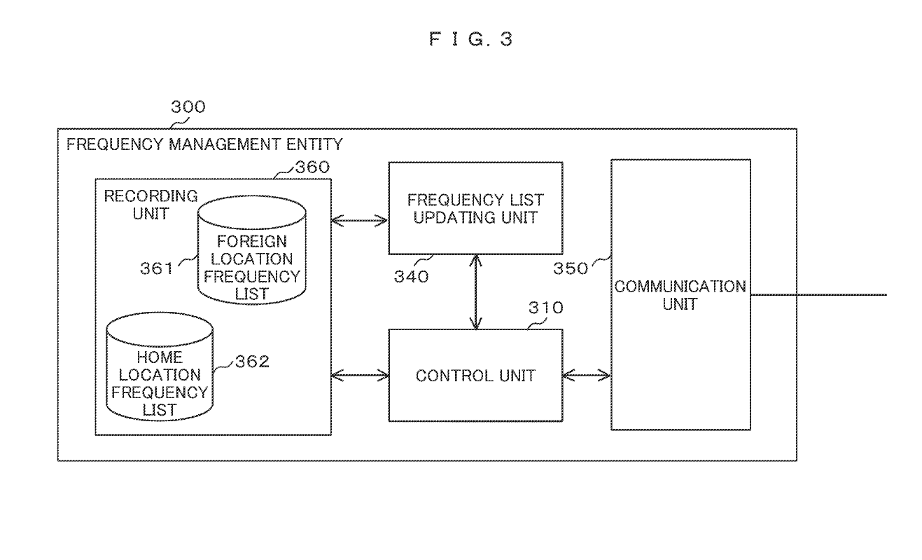

Referring to FIG. 3, a frequency management entity structure is described. In FIG. 3, a frequency management entity 300 includes a control unit 310, a frequency list updating unit 340, a communication unit 350, and a recording unit 360.

The control unit 310 performs control of all components of the frequency management entity 300. The frequency list updating unit 340 updates frequency lists 361, 362 which are contained in the recording unit 360. The communication unit 350 executes communication with a BS. The recording unit 360 records data.

The recording unit 360 contains a home location frequency list 362 and a foreign location frequency list 361. The home location frequency list 362 is information representing the center frequencies used by BSs installed in the home location. The foreign location frequency list 361 is information representing the center frequencies used by BSs installed in a foreign location.

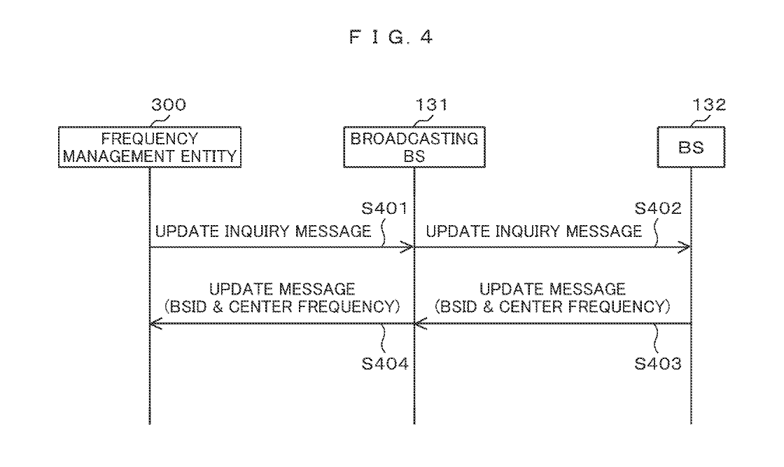

Referring to FIG. 4, descriptions are provided for a process in which a frequency management entity updates a frequency list it manages. In FIG. 4, a frequency management entity 300 creates an update inquiry message including a home location frequency list 362 which it has read from the storage unit 360 (S401). Through the communication unit, the frequency management entity 300 transmits the update inquiry message to a broadcasting BS 131 installed in the home location (S402). The broadcasting BS 131 transmits the update inquiry message to a BS 132 (S403). The BS 132 receives the update inquiry message and transmits an update message to the broadcasting BS 131 (S404).

The frequency management entity 300 transmits an inquiry message to inquire if a change has been made to the center frequency that each BS uses. If so, in an update message, a BS 132 transmits the center frequency of the BS that received the update inquiry message. The broadcasting BS 131 executes this message exchange processing to all BSs in the same location in a parallel way.

Through the communication unit 350, the control unit 310 of the frequency management entity receives the update message 402 from the broadcasting BS. The control unit 310 instructs the frequency list updating unit 340 to update the home location frequency list 362 which is contained in the storage unit 360, according to BSID and a center frequency included in the update message. The frequency list updating unit 340 updates the home location frequency list 362, using information representing the BSID and a new center frequency.

The description with FIG. 4 assumes the system structure in which respective frequency management functions 300 are installed in the locations A and B. However, a single frequency management entity may be provided in a framework where the frequency management functions 300 are interconnected by the Internet and updated. In that case, the Internet-connected frequency management entity 300 will transmit an update inquiry message to each of the broadcasting BSs 131 in the locations A and B and receive an update message from each of them. In this case, the Internet-connected frequency management entity collectively manages the frequency lists in the locations without discrimination between home/foreign locations and, therefore, update message transmission becomes unnecessary. Also in examples that will be described hereinafter, the frequency management entities installed in the respective locations can also be interpreted as the Internet-connected frequency management entity in an alternative framework.

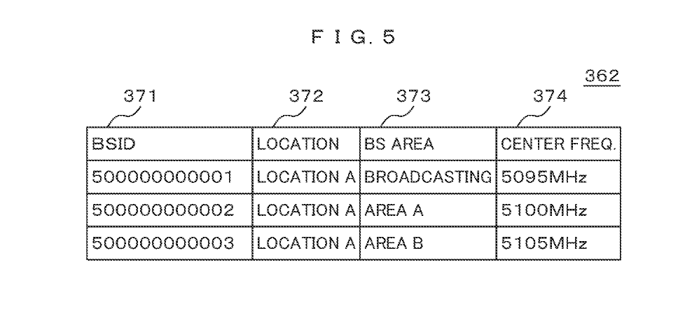

Referring to FIG. 5, descriptions are provided for a home location frequency list which is managed by the frequency management entity. The home location frequency list 362 presented in FIG. 5 is the home location frequency list 362 (particularly, 362-A) which is managed by the frequency management entity in the location A. The home location frequency list 362 stores information on the BSs 132-1 to 132-3 installed in the location A.

The home location frequency list 362 is comprised of the following fields: BSID 371, location 372, BS area 373, and center frequency 374.

BSID 371 is a BS identifier for identifying each BS. Location 372 indicates information representing a location to which an MS may move and where the BS is installed. BS area 373 indicates information representing a location to which an MS may move and which is a coverage area of the BS. Center frequency 374 indicates information representing a center frequency that the BS uses.

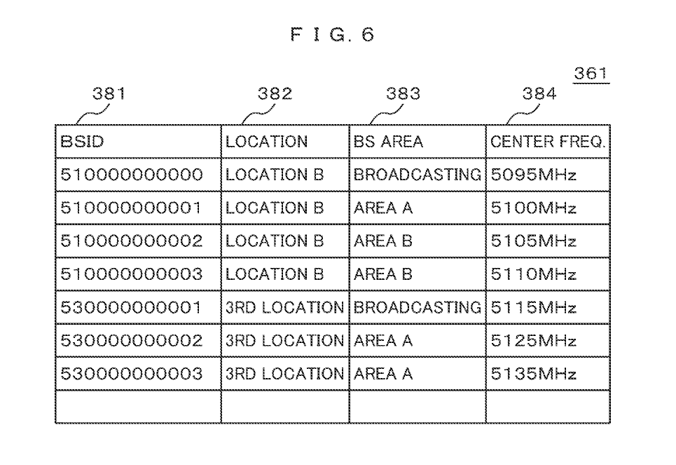

Referring to FIG. 6, descriptions are provided for a foreign location frequency list which is managed by the frequency management entity. The foreign location frequency list 361 presented in FIG. 6 is the foreign location frequency list 361 (particularly, 361-A) which is managed by the frequency management entity 300 in the location A. The foreign location frequency list 361 stores information on BSs installed in a location to which an MS may move and which is other than the location A. Like the home location frequency list 362, the foreign location frequency list 361 is comprised of the following fields: BSID 381, location 382, BS area 383, and center frequency 384. Here, the list stores information on the location B and a third location to which an MS may be destined to move from the location A. A maintenance person is assumed to set up the foreign location frequency list 361 beforehand.

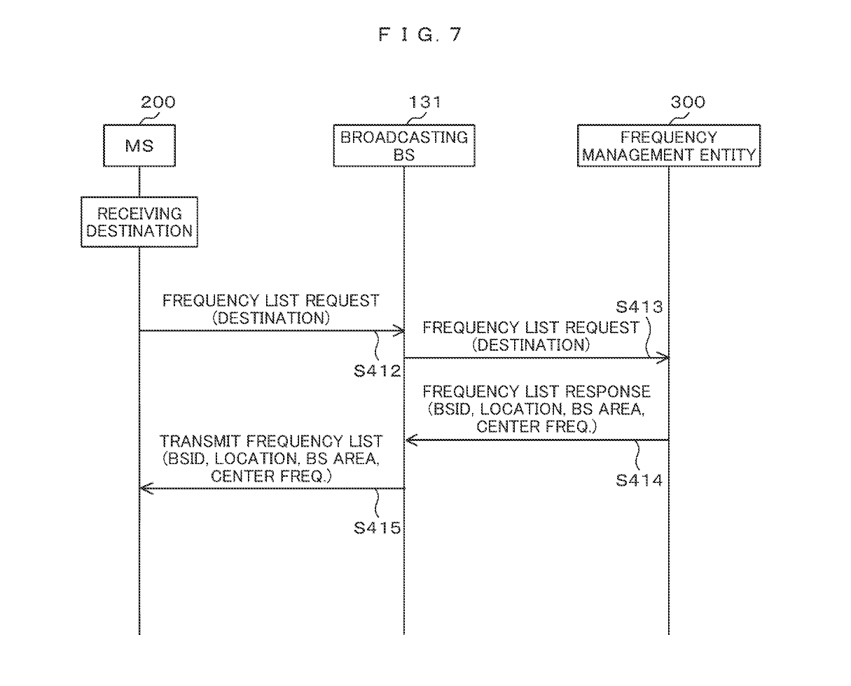

Referring to FIG. 7, descriptions are provided for a process in which an MS receives a frequency list. In FIG. 7, an MS 200 that stays in the location A receives its destination (S411). The MS 200 creates a message requesting a frequency list that contains information representing the center frequencies used by a broadcasting BS and BSs installed in the destination location and transmits the message addressed to a frequency management entity 300 through the baseband unit 210 and wireless transmitter 291 (S412). A broadcasting BS 131 relays the frequency list request message and transmits the frequency list request message to the frequency management entity 300 (S413).

The frequency management entity 300 receives the frequency list request message. The control unit 310 of the frequency management entity 300 retrieves a requested frequency list (all records relevant to the location B in this case) in the destination location from the foreign location frequency list 361 in the storage unit 360 and creates a frequency list response message from that information. Through the communication unit 350, the control unit 310 transmits the frequency list response message S414 to the broadcasting BS 131 (S414). The broadcasting BS 131 relays the frequency list response message and transmits the frequency list response message to the MS 200 (S415).

The control unit 212 of the MS 200 receives the frequency list response message through the wireless receiver 292 and baseband unit 210. The control unit 212 stores the received information into the frequency list 282 in the storage unit 280. The frequency list 282 has the same structure as the foreign location frequency list 361 described with FIG. 6 and includes the fields of BSID, location, BS area, and center frequency. If the destination is the location B, the frequency list holds all records with “location B” in the location field in the foreign location frequency list 361 presented in FIG. 6.

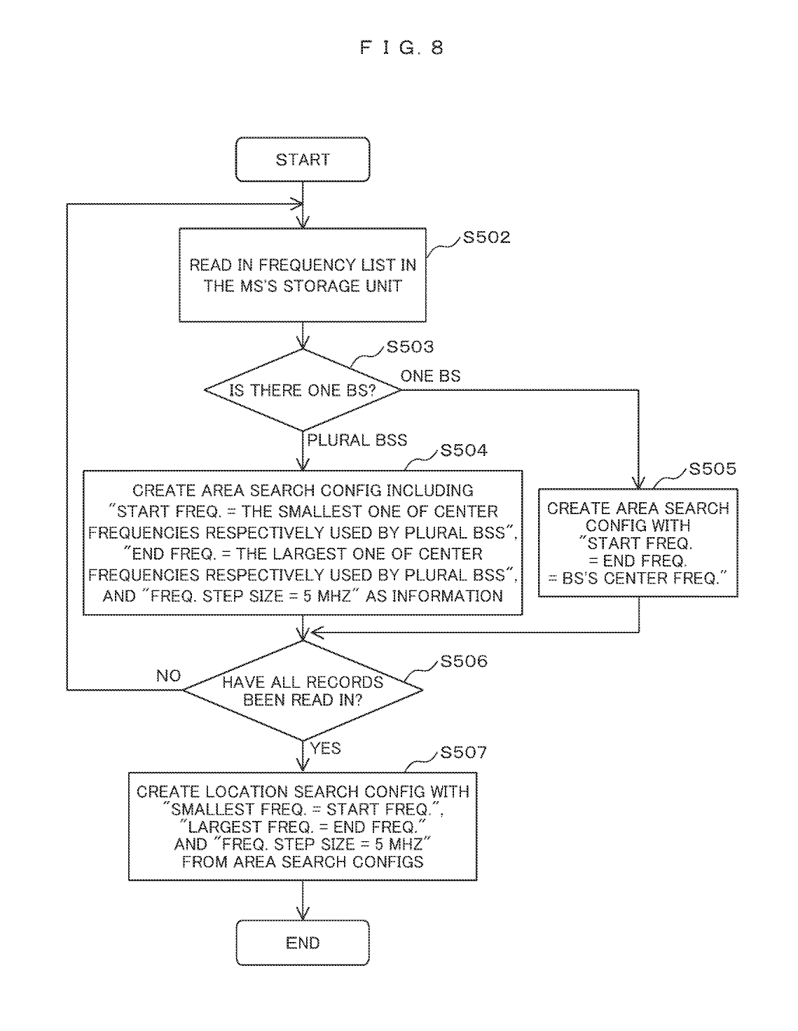

Referring to FIG. 8, descriptions are provided for a process in which an MS creates Area Search Config/Location Search Config based on a frequency list. Here, Search Config is an individual search list component created from a frequency list table. A search list is a collection of Search Configs. In the present embodiment, Area Search Config which is information for performing a search on a per-BS basis, Location Search Config for performing a search for all BSs existing in a location, and Default Search Config for performing a default search are stored in the search list.

The search list creating unit 220 reads in the records of BS areas covering destination locations to move to from the frequency list 282 in the storage unit 280 (S502). The search list creating unit 220 determines the number of BSs from the records that it reads in and determines how to create Search Config (S503). To illustrate, based on, particularly, the frequency list presented in FIG. 6, the search list creating unit 220 determines that one BS covers an area A in the location B and two BSs cover an area B in the location B.

If plural BSs cover an area of the destination, as determined at step 503, the search list creating unit 220 determines a start frequency, an end frequency, and a frequency step size and creates a Search Config to be used in performing a cell search (S504). As the start frequency, the unit 220 sets the smallest one of the center frequencies respectively used by the plural BSs that it reads in to the start frequency. As the end frequency, the unit 220 sets the largest one of the center frequencies respectively used by the plural BSs that it reads in to the end frequency. The unit 220 sets the frequency step size to 5 MHz.

On the other hand, if one BS, which is only a broadcasting BS, covers an area of the destination, as determined at step S503, the search list creating unit 220 determines a start frequency, an end frequency, and a frequency step size and creates a Search Config (S505). As the start/end frequencies, the unit 220 sets the center frequency used by the one BS that it reads in to the start and end frequencies. However, the search list creating unit 220 does not set the frequency step size. This is because the number of BSs to search for by a cell search is only one.

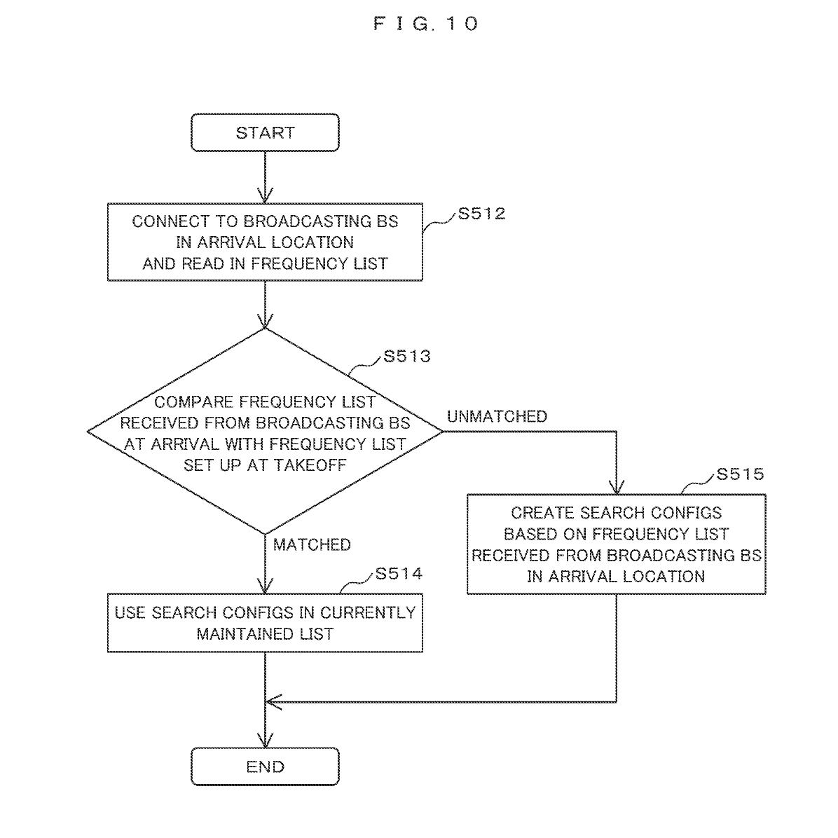

The search list creating unit 220 creates a Search Configs (Area Search Configs) for each of the BS areas of the destination location and maintains them in the search list 281 in the storage unit 280. The search list will be explained later, using FIG. 10.

The search list creating unit 220 checks whether or not it has read in all records with information in the location field matching the destination (S506). If there is a record of a BS read it has not read in yet, a return is made to step 502. When the decision is “YES” at step 506, the search list creating unit 220 creates a Location Search Config covering the frequencies used by the BSs in all BS areas (S507) and terminates the process.

At step 507, the search list creating unit 220 determines a start frequency, an end frequency, and a frequency step size and creates a Location Search Config to be used in performing a cell search. As the start frequency, the search list creating unit 220 sets the smallest one of the center frequencies used by the plural BSs that it reads in to the start frequency. As the end frequency, the search list creating unit 220 sets the largest one of the center frequencies used by the plural BSs that it reads in to the start frequency. The search list creating unit 220 sets the frequency step size to 5 MHz.

The search list creating unit 220 creates Search Configs (including a Location Search Config) in the destination and maintains them in the search list in the storage unit 280.

For the frequency step size, the search list creating unit 220 sets an appropriate value according to the width of gaps between the center frequencies of BSs adopted in the wireless communication system. Because AeroMACS is assumed as the wireless communication system here, the search list creating unit 220 sets the frequency step size to 5 MHz. If there are plural wireless networks to which an MS may connect to, the search list creating unit 220 sets the frequency step size according to the width of gaps between the center frequencies of BSs prescribed in the communication system of a wireless network to which the MS is to connect to. In the present embodiment, the search list creating unit 220 of an MS sets the frequency step size to a fixed value (5 MHz) specific to the AeroMACS network.

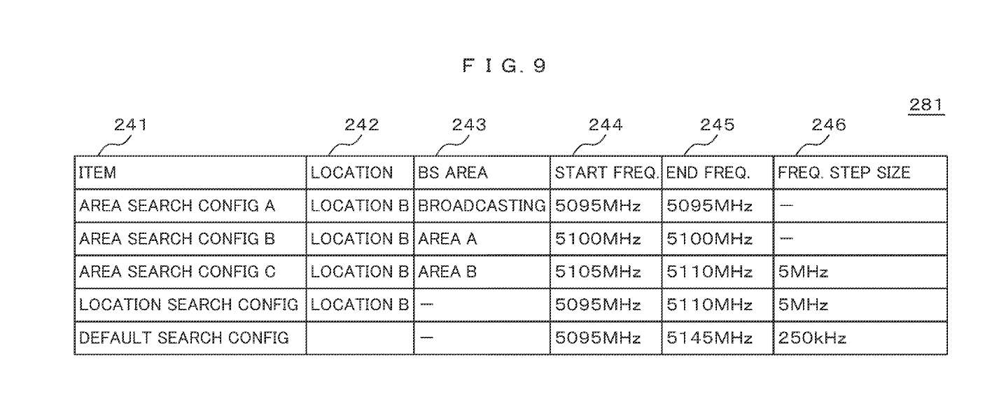

Referring to FIG. 9, a search list that an MS maintains is described. The search list 281 in FIG. 9 is comprised of Area Search Configs and a Location Search Config created according to the flowchart of FIG. 8 and a Default Search Config. The search list 281 is used when the MS performs a cell search in the destination location B.

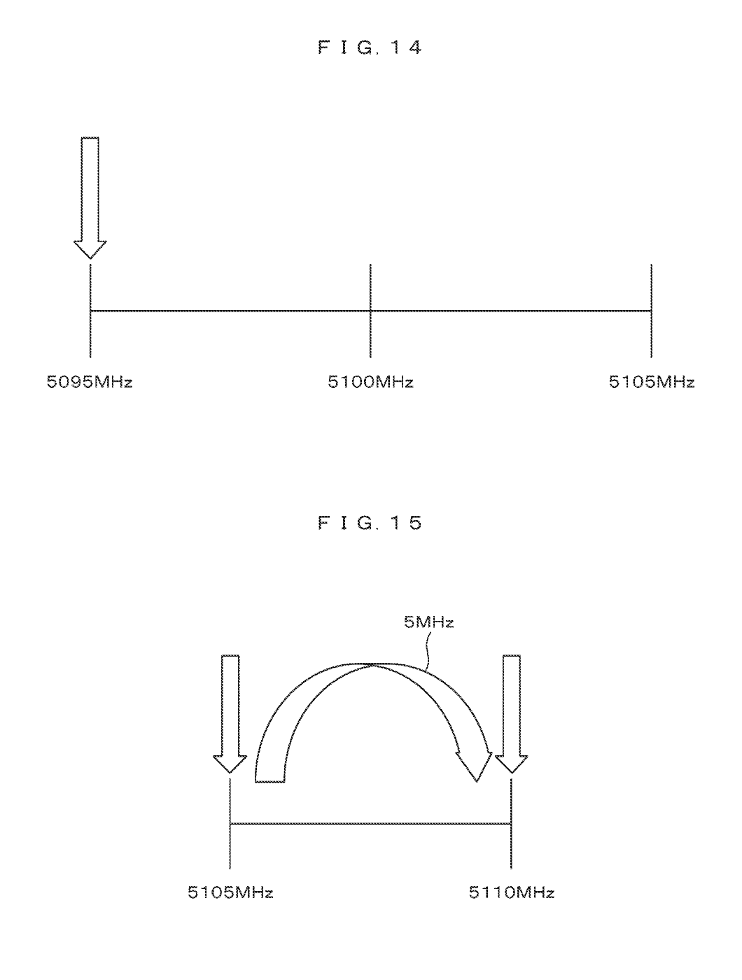

The search list 281 in FIG. 9 includes the following fields: item 241, location 242, BS area 243, start frequency 244, end frequency 245, and frequency step size 246. How to use the search list will specifically be described later with reference to FIGS. 14 to 17.

Referring to FIG. 10, descriptions are provided for a process of comparing a frequency list that an MS maintains and a frequency list received from the broadcasting BS in the location B. In FIG. 10, when an MS 200 moves to the destination location B, its control unit 212 completes network entry, using an Area Search Config identified with “Broadcasting” specified in the BS area field of the list of Area Search Configs.

The control unit 212 of the MS 200 reads in a frequency list in the location B received via the broadcasting BS 131-B (S512). The control unit 212 compares the frequency list with a frequency list 282 stored at takeoff from the location A (S513). If both lists match, the control unit 212 performs a cell search for a location to move to, using Area Search Configs in the currently maintained list (S514).

If the comparison result is unmatched at step 513, the control unit 212 creates Area Search Configs/Location Search Config based on the frequency list received from the broadcasting BS 131-B in the location B and performs a cell search using Area Search Configs identified with “Location B” specified in the BS area field (S515).

When the MS performs a cell search using Area Search Configs, if the cell search is unsuccessful, the control unit 212 performs a cell search using a Location Search Config as recovery measures. If the cell search using the Location Search Config is unsuccessful again, the control unit 212 performs a cell search using a Default Search Config as recovery measures. The Default Search Config is defined with a search range and a frequency step size prescribed in the wireless communication system and pre-stored in the search list. Because AeroMACS is assumed as the wireless communication system here, if the MS performs a cell search using the Default Search Config, the MS performs a cell search in a range from 5095 MHz to 5145 MHz in frequency steps of 250 kHz.

Because the AeroMACS network is applied in the present embodiment, one Default Search Config only exists in the search list. If the MS 200 is a terminal which may connect to plural wireless communication systems, the search list includes as many Default Search Configs as the number of the wireless communication systems; in each Default Search Config, a start frequency, an end frequency, and a frequency step size prescribed in each wireless communication system are stored.

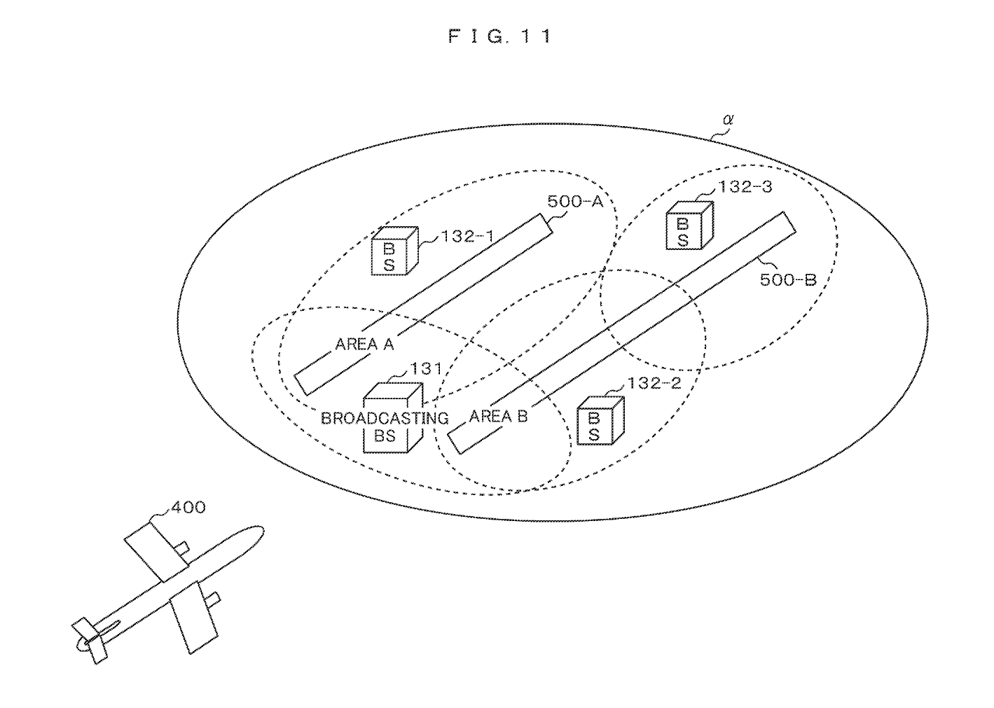

Referring to FIG. 11, descriptions are provided for an aircraft approaching the destination location B and a coverage area α of the broadcasting BS and BSs installed in the location, where the AeroMACS network is applied. The coverage area α indicates a scope in which the broadcasting BS 131 and BSs 132-1 to 132-3 installed in the location B can connect with an MS. In particular, when an MS 200 initiates mobile communication, first, the MS is to connect to the broadcasting BS 131 and execute operations described in FIG. 10. Then, the MS 200 is to perform communication with one of the BSs 132-1 to 132-3. To perform communication with the BS 131 and one of the BSs 132, the MS installed in the aircraft 400 must enter the coverage areas of the BSs. The location B is covered by the coverage areas of the BSs and a part of the location B is covered by the coverage areas of plural BSs.

The MS 200 is to perform communication with the broadcasting BS 131 at its arrival. The MS 200 is to perform communication with a BS 132-1 when it lands and moves on ground in an area A. The MS 200 is to perform communication with either a BS 132-2 or a BS 132-3 when it lands and moves on ground in an area B.

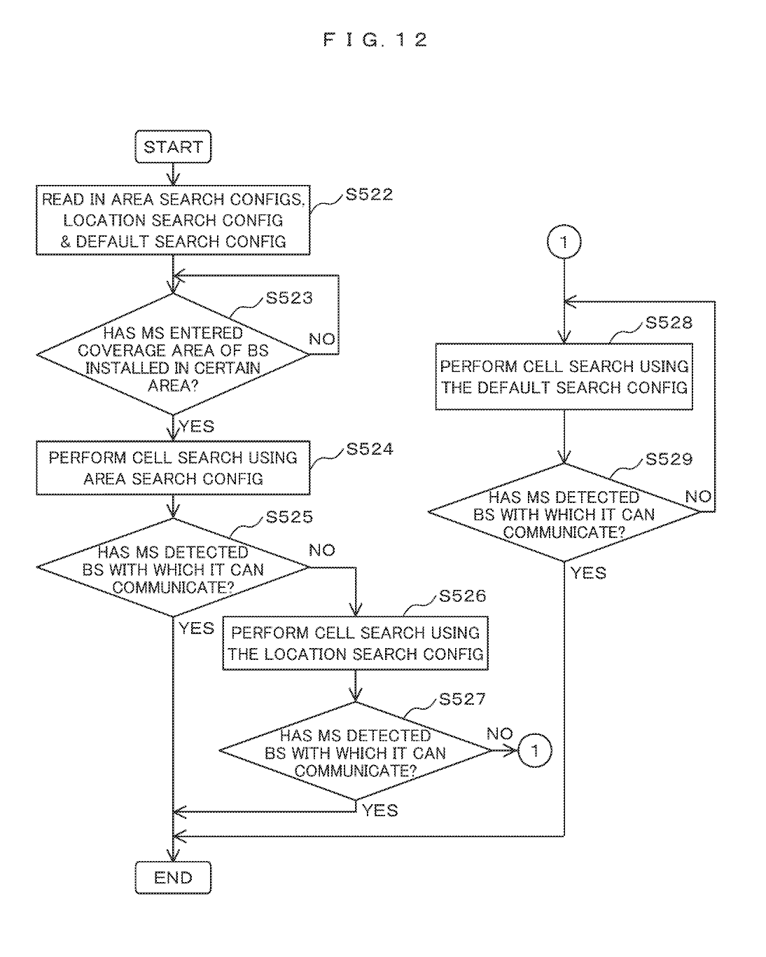

Referring to FIG. 12, descriptions are provided for a process in which an MS performs a cell search using Area Search Config in the location B. In FIG. 12, upon arrival and after connecting to the broadcasting BS 131 and executing operations described in FIG. 10, the control unit 212 of the MS 200 reads in Area Search Configs, a Location Search Config, and a Default Search Config in the location B from the search list 281 in the storage unit 280 to perform communication with a BS in the location B (S522).

To decide whether or not the MS has entered the coverage area of a BS installed in the location B, the control unit 212 executes Initial Ranging to search for a usable channel and a base station (S523). When the decision is NO, the control unit 212 repeats step 523. Once the MS 200 has entered a BS's coverage area (S523; YES), the control unit 212 performs a cell search using an Area Search Config (S524). The control unit 212 checks whether or not it has detected a BS using the Area Search Config (S525). If no BS is detected, the control unit 212 performs a cell search using the Location Search Config (S526). The control unit checks whether or not it has detected a BS using the Location Search Config (S527).

If no BS is detected again, the control unit 212 performs a cell search using the Default Search Config (S528). The control unit 212 checks whether or not it has detected a BS using the Default Search Config (S529). The control unit 212 continues to perform a cell search using the Default Search Config until it detects a BS.

Upon detecting a BS with which the MS can communicate at step 525, step 527, or step 528, the control unit 212 terminates cell search processing, attains synchronization with the detected BS, and then initiates network entry processing.

It is preferable that the control unit 212 uses Area Search Configs only in a phase prior to network entry which is first executed after disconnection from the broadcasting BS 131. After network entry has once been performed and the MS has connected to a BS detected, using Area Search Configs, when the MS is disconnected from the network for any reason, e.g., disconnection from the network because of blockage within the BS area, and the MS attempts to connect to a BS installed within the location B again, the control unit 212 is to perform a cell search using the Location Search Config.

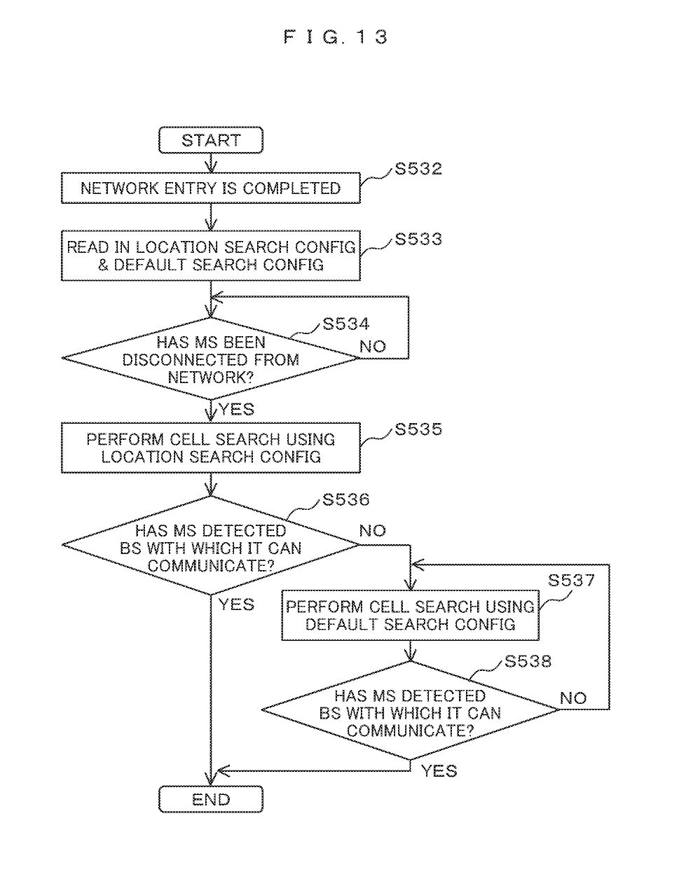

Referring to FIG. 13, descriptions are provided for a process in which the MS performs a cell search using a Location Search Config. In FIG. 13, in consequence of the process in FIG. 12, network entry is completed (S532). The control unit 212 reads in a Location Search Config and a Default Search Config in the destination location from the search list 281 in the storage unit 280 (S533).

The control unit 212 checks whether or not the MS has been disconnected from the network after the completion of network entry (S534). When the decision is NO, the control unit 212 repeats step 534. When the decision at step 534 is YES, the control unit 212 performs a cell search using the Location Search Config (S535). The control unit 212 checks whether or not it has detected a BS using the Location Search Config (S536). If no BS is detected, the control unit 212 performs a cell search using the Default Search Config (S537). The control unit 212 continues to perform a cell search using the Default Search Config until it detects a BS. Upon detecting a BS with which the MS can communicate at step 536 or step 538, the control unit 212 terminates cell search processing, attains synchronization with the detected BS, and then initiates network entry processing.

During a period until a next destination of the MS 200 is determined and the MS starts to move, the control unit 212 performs a cell search using the Location Search Config or Default Search Config in the location B.

Descriptions are provided for a cell search that is performed at handover (i.e., the moving MS switches to another BS) after the previous connection (network entry). For a cell search to be performed at handover, the MS applies a cell search prescribed in mobile WiMAX. After completing network entry with a BS, the MS 200 receives a Mobility Neighbor Advertisement (MOB_NBR-ADV) message from the BS as broadcasting information. The NBR-ADV message includes the center frequency used by a neighboring BS as information. The mobile WiMAX prescribes that the MS should perform a cell search for only this center frequency when performing handover and switching to another BS to which it should connect.

Referring to FIG. 14, descriptions are provided for a scheme of cell search processing with Area Search Config A in FIG. 9. In FIG. 14, the MS 200 searches for 5095 MHz only. The MS 200 performs a search only once. Here, this Search Config is used as the Area Search Config in a case where only one BS exists; i.e., a cell search for the broadcasting BS 131 is performed.

Referring to FIG. 15, descriptions are provided for a scheme of cell search processing with Area Search Config C in FIG. 9. In FIG. 15, the MS 200 performs a search in a range from 5105 MHz to 5110 MHz in frequency steps of 5 MHz. The MS 200 performs a search twice from the start frequency of 5105 MHz.

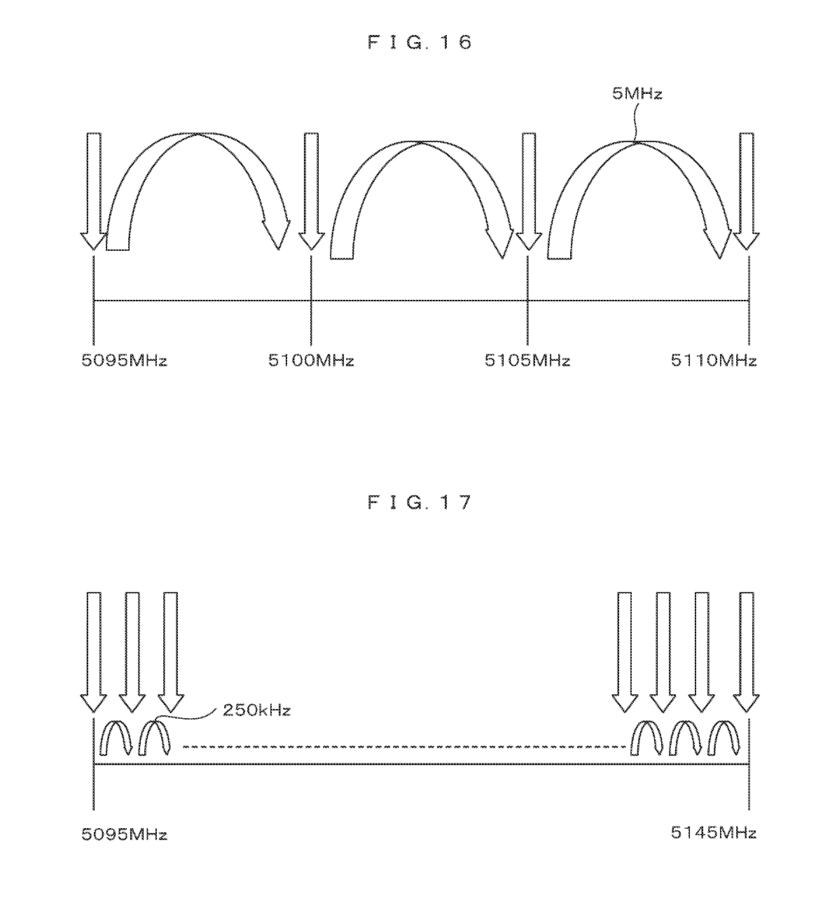

Referring to FIG. 16, descriptions are provided for a scheme of cell search processing with Location Search Config in FIG. 9. In FIG. 16, the MS 200 performs a search in a range from 5095 MHz to 5110 MHz in frequency steps of 5 MHz. The MS 200 performs a search four times from the start frequency of 5095 MHz.

Referring to FIG. 17, descriptions are provided for a scheme of cell search processing with Default Search Config in FIG. 9. In FIG. 17, the MS 200 performs a search in a range from 5095 MHz to 5415 MHz in frequency steps of 250 kHz. The MS 200 performs a search by 201 times at a maximum if the center frequency of a BS 200 with which the MS is to attain synchronization is set to 5145 MHz.

A cell search using Default Search Config should be performed as recovery measures against the failure of cell searches using Area Search Config and Location Search Config. Except for a cell search for the broadcasting BS 131, the MS 200 should perform a cell search using Area Search Config only once and a cell search using Location Search Config only once. After the failure of all these searches which should be performed once, the MS 200 is to perform a cell search using Default Search Config. The MS 200 should perform a cell search using Default Search Config repeatedly until it detects a BS with which it can communicate.

In the illustrations of cell searches in the AeroMACS communication system, presented in FIGS. 14 to 16, the number of cell search actions required for a cell search using Area Search Config or Location Search Config is reduced in comparison with a cell search using Default Search Config. Accordingly, time for a cell search is reduced, and additionally, it is possible to succeed a cell search reliably because the MS is provided with cell search schemes in three stages.

According to the present embodiment, before an MS performs a cell search in its destination (more specifically, at takeoff), the MS is provided in advance with information representing the center frequencies used by BSs for which a cell search will be performed. After moving to the destination, by comparing a frequency list that the MS maintains with a frequency list received from the broadcasting BS in the destination location, it can be checked whether or not the frequency list maintained is applicable. Accordingly, time that the MS takes to complete a cell search is reduced and a cell search can be performed reliably.

Further, it would be easy to response to an unexpected change in a destination network after moving to the destination. By executing the process illustrated in FIG. 10 by the MS, an adaptive operation can be carried out in a case where the destination network has intentionally changed a frequency list and the MS has to perform a cell search for an arbitrary frequency. More efficient use of BS resources can be achieved.

Because the MS has a function of changing the frequency step size as a function of creating a search list, the present example is applicable to an MS which may connect to plural wireless communication systems where the width of gaps between the center frequencies used by BSs differs.

While the present embodiment concerns the wireless airport surface communication system, the present embodiment can also be applied to a system where an MS moves from a location to another and moves to another network and another wireless communication system, other than the airport surface communication system. In that case, once a destination location has been determined, the MS receives a frequency list of BSs covering areas in the destination location before disconnection from the network. According to the contents of the frequency list, the MS calculates a search range and a frequency step size and creates and stores Search Configs which are used in performing a search.

When performing a cell search in the destination location, the MS connects to a broadcasting BS using Search Config created in advance, based on the frequency list in the destination location, and compares the pre-acquired frequency list before it moves with a frequency list in the destination location received from the broadcasting BS. According to the result of the comparison, the MS performs a cell search for a BS using Search Config created in advance before it moves or Search Config created based on the frequency list received from the broadcasting BS in the destination. Thereby, it is possible to reduce time for a cell search and perform a cell search reliably. If no BS is detected by searching in a search range defined in the Search Config, the MS performs a cell search by searching through all applicable frequencies that are used in the destination wireless communication network as recovery measures. If no BS is detected yet, as further recovery measures, the MS is to perform a cell search for a BS by continuing to search in a search range in fine frequency steps, defined in the wireless communication system that the MS supports.

As the application scope of the technique set forth in the present specification, the technique is applicable to mobile wireless communication systems other than AeroMACS. The technique is applicable to wireless communication systems which are currently put in practical use, including, in particular, Long Term Evolution (LTE) and WiMAX, and wireless communication systems which will be put into practical use in the future.

What is claimed is:

1. A wireless communication base station system comprising a first broadcasting wireless base station that broadcasts information on wireless base stations installed in a first location, a second broadcasting wireless base station that broadcasts information on wireless base stations installed in a second location, and a frequency management entity,
wherein the frequency management entity includes a control unit that performs message transmission and reception and a storage unit that stores information representing center frequencies which are used by wireless base stations in the second location and a coverage area, and
wherein the control unit, upon receiving a message requesting information on the wireless base stations installed in the second location from a wireless mobile station which is going to move from the first location to the second location, transmits information on the wireless base stations installed in the second location, which is stored in the storage unit, to the wireless mobile station via the first broadcasting wireless base station.

2. The wireless communication base station system according to claim 1, further comprising a first wireless base station in the first location and a second wireless base station in the second location.

3. A wireless communication system comprising a first broadcasting wireless base station that broadcasts information on wireless base stations installed in a first location, a second broadcasting wireless base station that broadcasts information on wireless base stations installed in a second location, a mobile wireless station that performs wireless communication with a wireless base station, and a frequency management entity,
wherein the frequency management entity includes a control unit that performs message transmission and reception and a storage unit that stores information representing center frequencies which are used by wireless base stations in the second location and a coverage area,
wherein the wireless mobile station includes a mobile station control unit that performs message transmission and reception and compares information on wireless base stations,
wherein the mobile station control unit, when the mobile station is going to move from the first location to the second location, transmits a message requesting information on the wireless base stations installed in the second location which is a destination to the frequency management entity via the first broadcasting wireless base station, and
wherein the control unit, upon receiving a message requesting information on the wireless base stations installed in the second location from the wireless mobile station, transmits information on the wireless base stations installed in the second location, which is stored in the storage unit, to the wireless mobile station via the first broadcasting wireless base station.

4. The wireless communication system according to claim 3, further comprising a first wireless base station in the first location and a second wireless base station in the second location.

5. The wireless communication system according to claim 4,
wherein the wireless mobile station further includes a mobile station storage unit,
wherein the mobile station storage unit pre-stores the smallest and largest ones of center frequencies which are used in the wireless communication system and the smallest frequency step to search through frequencies as a Default Search Configuration and stores Search Configurations, and
wherein the mobile station control unit, upon receiving information on base stations from the frequency management entity via the first broadcasting wireless base station and deciding that a plurality of the second wireless base stations serve the coverage area, creates an Area Search Configuration in which the smallest and largest ones of center frequencies used by the plurality of second wireless base stations are set as search start and end frequencies for a cell search and a frequency step size to search defined in the wireless communication system is set as frequency steps, and stores the Area Search Configuration into the mobile station storage unit.

6. The wireless communication system according to claim 4,
wherein the wireless mobile station further includes a mobile station storage unit,
wherein the mobile station storage unit pre-stores the smallest and largest ones of center frequencies which are used in the wireless communication system and the smallest frequency step to search through frequencies as a Default Search Configuration and stores Search Configurations, and
wherein the mobile station control unit, upon receiving information on base stations from the frequency management entity via the first broadcasting wireless base station and deciding that one second wireless base station serves the coverage area, creates an Area Search Configuration in which a center frequency used by the second wireless base station is set as search start and end frequencies, and stores the Area Search Configuration into the mobile station storage unit.

7. A mobile wireless station that may be connected to a wireless communication base station system including a first broadcasting wireless base station that broadcasts information on wireless base stations installed in a first location, a second broadcasting wireless base station that broadcasts information on wireless base stations installed in a second location, and a frequency management entity,
the mobile wireless station comprising a mobile station control unit that performs message transmission and reception and compares information on wireless base stations and a mobile station storage unit,
wherein the mobile station control unit, upon receiving information on base stations from the frequency management entity via the first broadcasting wireless base station and deciding that a plurality of the second wireless base stations serve the coverage area, creates an Area Search Configuration in which the smallest and largest ones of center frequencies used by the plurality of second wireless base stations are set as search start and end frequencies for a cell search and a frequency step size to search defined in the wireless communication system is set as frequency steps, and stores the Area Search Configuration into the mobile station storage unit, and
wherein the mobile station control unit, upon receiving the information on base stations and deciding that one second wireless base station serves the coverage area, creates an Area Search Configuration in which a center frequency used by the second wireless base station is set as search start and end frequencies, and stores the Area Search Configuration into the mobile station storage unit.
